(19) United States
(12) Patent Application Publication
(10) Pub. No.: US 2003/0126080 A1
(43) Pub. Date: Jul. 3, 2003

(54) Method and apparatus for communicating over a public computer network

(76) Inventor: Melih Ogmen, Ariss (CA)

Correspondence Address: Orange & Chari, Suite 4900, 66 Wellingtou Street West, P.O. Box 190, Toronto, ON, M5K 1H6, CA

(21) Appl. No.: 10/301,654

(22) Filed: Nov. 22, 2002

(30) Foreign Application Priority Data
Nov. 22, 2001 (CA) 2,363,629
Mar. 22, 2002 (CA) 2,378,542

(51) Int. Cl. G06F 17/60

(52) U.S. Cl. 705/40; 705/39; 705/26

(57) ABSTRACT

A method of processing a credit card transaction between a seller and a buyer over a network using a credit company. The method comprises the seller sending a sender identification and a product ID to the buyer. The buyer sends a buyer ID, the seller ID, the product ID and a price to the credit company. The credit company sends a bill to the buyer. The credit company sends payment to the seller, and the seller sends the product to the buyer.

### BACKGROUND OF THE INVENTION

1. Field of the Invention

The present invention relates generally to communicating over a public network, and more particularly to processing credit card transactions over all public computer network

2. Description of the Prior Art

There are three general categories of computer networks with respect to their utilization: private networks, public networks, and Virtual Private Networks (VPN's).

Private networks are usually encountered in business enterprises or other organizations. In these networks the network administrators may strictly control both access to the network resources and the content of traffic between the network members.

In private networks, the operating hardware, computer protocols and the network configuration may be strictly controlled and in most cases involve customized hardware and/or software. When the private network is constrained to one office, such networks are usually referred to as Local Area Networks (LANs). Wide Area Networks (WAN) utilize leased communication lines to create a private network over longer distances. However, the leased lines required are often expensive.

Public networks are generally classified as networks where a broad-based participation of users is allowed and encouraged. The Internet and the World Wide Web that it supports is one such system. However, such networks are inappropriate for corporate communications since there are no limits on who can access the network.

The Internet is a public network and is very difficult to impose control over. Internet users can “cloak” their identity by surfing the net through anonymous proxy servers, easily distribute viruses and other damaging micro programs, perform credit card fraud, and damage computer Systems through hacking activities. The current state of the Internet can therefore be characterized as chaotic, uncontrolled and insecure.

Virtual Private Networks (VPN) are used by distributed enterprises that desire the convenience and security of a private network despite remote physical locations of the enterprise components, yet do not want to incur the extra expense of leased lines to implement a WAN. A VPN operates on top of an existing public network, yet provides the security features normally associated with a private network.

The following U.S. patents disclose methods for creation of VPNs over a public network: U.S. Pat. No. 6,061,796 “Multi access virtual private network” by James F. Chen ct al., U.S. Pat. No. 6,078,586 “ATM Virtual Private Networks” by Andrew J. Dugan et al., U.S. Pat. No. 6,105,132 “Computer network graded authentication system and method” by Daniel Gene Fritch et al., U.S. Pat. No. 6,178,505 “secure delivery of information in a network” by David S. Schneider., U.S. Pat. No. 6,205,488 “Internet protocol virtual private network realization using multi-protocol label switching tunnels” by Liam M. Casey et al., U.S. Pat. No. 6,226,748 “Architecture for virtual private networks” by Henk J. Bots et al., U.S. Pat. No. 6,295,556 “Method and system for configuring computers to connect to networks using network connection objects” by Stephen R. Falcon et al., and U.S. Pat. No. 6,055,575 “Virtual private network system and method” by Gaige B. Paulsen et al.

Most private computer networks and VPNs are also connected to the Internet to provide access to the Internet for their members.

In computer networks, the security of the data and the communication channel are a concern to varying degrees.

The general principle that is applied by the prior art to data/communication security over the Internet is shown in FIG. A. A user I is attempting to communicate with a user 2 over the Internet. The User 1's computer system or network gateway, through the use of appropriate hardware or software combination, attempts to find answers to the following questions:

1. Did I establish a connection with “User 2”?

2. Is the “&User 2” really who it claims to be?

3. How do I prevent third parties from eavesdropping while the message goes through the internet?

There is a wide body of prior art available describing unique methods that generally try to establish unique and innovative answers to one or more of the questions listed above, for example smart cards and their variants, and biometric technologies. FIG. B shows a more general case of a user within a LAN interacting with another user within a WAN through the Internet.

In FIG. B, the user 1 is protected from the Internet by the use of a Firewall, which is shown as Gateway 1. A firewall is a barrier between a LAN, a WAN or a standalone client and the Internet. Firewalls and gateways consist of software and hardware components, which act as an access filter. Many such filtering schemes exit. The filter checks requests that arrive from the Internet for a resource that is within the LAN or the WAN. The filter sends the request to the internal network if and only if the request is coming from an identifiable source with the right to access the information. If this check fails then the request is discarded.

The firewall filter attempts to answer the question of whether the user 2 is who it claims to be by the use of a process called authentication. This is generally achieved through the use of tokens. A token is a small piece of code that includes information about the user, their machine, the operating system identification, the Internet Protocol (IF) address and domain names.

There are many different kinds of tokens, filters and other schemes such as token-less identification and biometrics etc. that serve to answer the same authentication question. There is a rich source of published material on this subject. Some of the more popular references are: Firewalls and Internet security by S. Bellovin and W. Cheswick, Addison Wesley, Reading, Mass., 1994, Building Internet Firewalls by E. D. Zicky et al., O'Riley & Associates, 2000 and Computer Forensics by W. G. Kruse II and S. G. Heiser, Addison-Wesley Pub. Co. 2001.

The visible Internet chaos stems from the difficulty in identifying hosts that are on the Internet at a given time.

The Internet Protocol (IP), the transport program (TCP) and User Datagram Protocol (UDP) are designed and used to transmit messages between different computer networks. Each Internet interface is identified by a 32-bit Internet address. When the Internet protocol (IP) was standardized in 1981, these addresses were identified as two part objects: a network identifier and a host number within that network. The Internet numbering authorities designate the network numbers, which are unique worldwide. The network manager assigns the host numbers within their network. In 1984 a third hierarchical level called a subnet was added to the structure. A subnet is a division of the addressing space reserved for a network.

Though the uniqueness of host numbers, within one network, combined with worldwide uniqueness of the network numbers creates an impression of an ability to uniquely identify hosts that are on the network, generally this is not the case since Internet addresses do not designate hosts. They are identifiers of network interfaces. A host with several interfaces will have many addresses. Furthermore, the network topology can dynamically change over time. Customers may change providers, company backbones may be reorganized, and providers may merge or split. If the topology changes with time and if the addresses must somehow reflect the topology, then addresses will have to change from time to time. Therefore IP addresses do have lifetimes. An address whose lifetime has expired becomes invalid.

The IP is a highly effective protocol for providing connectivity between various computer networks, but it is extremely ineffective for determining who injected a virus onto a network or who was hacking into a network. The underlying reason for this is that the Internet was built as a network of computers, not people.

In credit card related transactions, the system functions on the principle that the cardholder is the gatekeeper and controls and polices the use of that particular card and hence his credit card number as shown in FIG. 11. Though this particular transaction system works reasonably well in society where physical goods and credit are exchanged on the spot it is not very effective when it is applied to the financial transactions on the Internet. Because the credit card number is transmitted through a highly insecure environment and goods and credit information are not exchanged on a one-to-one basis, the overall transaction is open to fraud and abuse.

Another problem with the use of credit cards on the Internet stems from the purchaser's inability to verify the legitimacy of the seller. In a real market place, generally the existence, size and quality of the physical establishment serves as a relative assurance to the purchaser of the legitimacy of the seller. On the Internet the apparent size and quality of a web site has no correlation to the legitimacy of the seller.

It will therefore be appreciated that the physical marketplace based credit card system is not well suited for financial transactions on the Internet.

It is an object of the present invention to obviate or mitigate some of the above disadvantages.

### SUMMARY OF THE INVENTION

In accordance with one aspect of the present invention, there is provided a method of processing a credit card transaction between a seller and a buyer using a credit company comprising the seller sending a sender identification and a product ID to the buyer, the buyer sending a buyer ID, the seller ID, the product ID and a price to the credit company, the credit company sending a bill to the buyer, the credit company sending payment to the seller, and the seller sending the product to the buyer.

The present invention attempts to eliminate the premise that the prior art is built on, namely that the Internet is chaotic, uncontrolled and insecure, by devising a method to bring law and order to the Internet. A much simpler method of user accountability and traceability is provided as the prime source for Internet security. With the present method, the Internet is relatively orderly and secure and therefore the need for firewalls and other methods is diminished and could potentially be eliminated in proportion to the general security provided by this method.

In accordance with another aspect of the present invention, there is provided a method of logging a user into a network comprising the steps of obtaining a user ID by registering with the network, requesting a permit from an archive on the network. the archive verifying that the use is registered with the network, and the archive sending the permit to the user.

In accordance with yet another aspect of the present invention, there is provided a method of communicating between a first user and a second user on a network, each user including a respective user ID and a respective SNAP ID. The method comprises the steps of the first user sending an activity request to an archive on the network, the first user sending the activity request to the second user, the second user sending a verification request to the archive, and the archive verifying the first user and sending the verification to the second user.

### BRIEF DESCRIPTION OF THE DRAWINGS

These and other features of the preferred embodiments of the invention will become more apparent in the following detailed description in which reference is made to the appended drawings wherein:

FIG. A is a schematic representation of a prior art method.

FIG. B is a schematic representation of a prior art method.

FIG. C is a schematic representation of a prior art method.

FIG. D is a schematic representation of a prior art method.

FIG. 1 is a schematic representation of a communication system.

FIGS. 2 is a schematic representation of a data structure used in the communication system of FIG. 1.

FIG. 3 is a schematic representation of a data structure used in the communication system of FIG. 1.

FIG. 4 is a schematic representation of a data structure used in the communication system of FIG. 1.

FIG. 5 is a schematic representation of a data structure used in the communication system of FIG. 1.

FIG. 6 is a schematic representation of a method performed by the correspondents of FIG. 1.

FIGS. 7 is a schematic representation of a method performed by the correspondents of FIG. 1.

FIG. 8 is a schematic representation of a method performed by the correspondents of FIG. 1.

FIG. 9 is a schematic representation of a method performed by the correspondents of FIG. 1.

FIG. 10 is a schematic representation of a method performed by the correspondents of FIG. 1.

FIG. 11 is a schematic representation of a method performed by the correspondents of FIG. 1.

FIG. 12 is a schematic representation of a further method performed by the correspondents of FIG. 1.

FIG. 13 is schematic representation of another method performed by the correspondents of FIG. 1.

FIG. 14 is schematic representation of a yet further method performed by the correspondents of FIG. 1.

### DESCRIPTION OF THE PREFERRED EMBODIMENTS

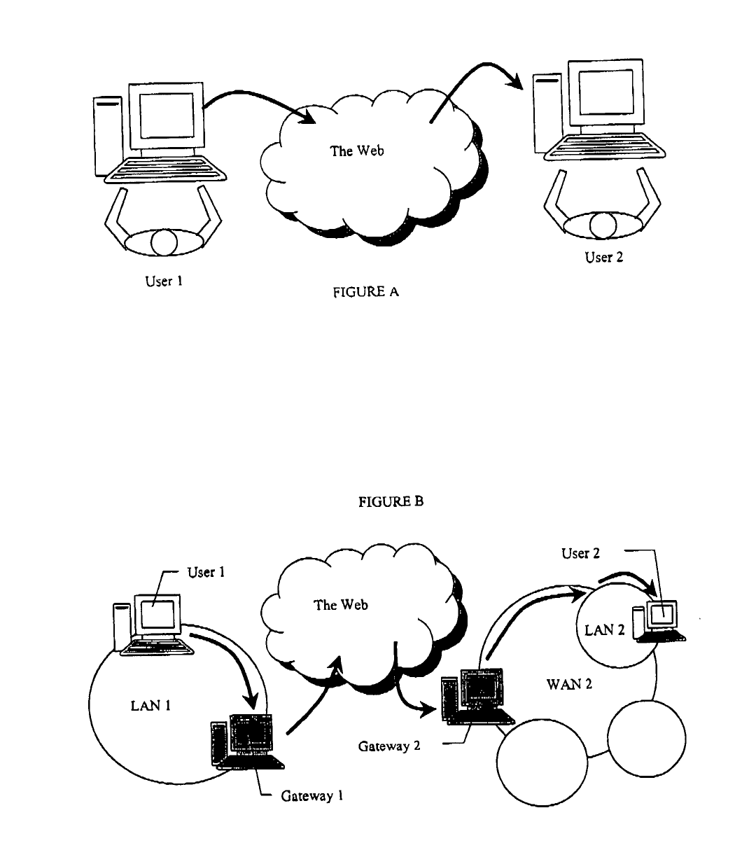

Referring to FIG. 1, a schematic representation of a network is shown generally by the numeral 10. A plurality of users, shown as a first user (User 1) 12 and a second user (User 2) 14, for the sake of examples each have a respective User ID 16, 17 and a Safe Net Application (SNAP) 18, 19. Each SNAP 18, 19 has an associated SNAP ID which is generated uniquely from parameters of the underlying computer system. The users are both connected to the Internet 30 for communications. Also connected to the Internet 30 is a TAG Archive 20, a Safe Net Security Service 22, and a Safe Net Credit Company 24. The users 12, 14 communicate with each other over the Internet 30 by using the TAG Archive 20. The TAG Archive comprises a plurality of Safe Net servers. The Safe Net Security Service 22 monitors communications through the Internet 30 using the TAG Archive 20. The Safe Net Credit Company 24 provides payment services to the users.

In the following, it will be recognized that the network 10 facilitates accountability and traceability of transactions. These improvements nevertheless maintain the richness and diversity of the Internet. The User ID's 16, 17, a TAG data structure, and the TAG archive 20 are used to provide accountability and traceability.

Members of every society need a passport number to enjoy the privileges of citizenship associated with that society all over the world. They need a health insurance card number to be able to access the health care system. They need a driver's license number to have access to the privilege of private transportation. All modem societies are built on the concept of licensing individuals for a privilege of access to a service or a right, and in turn demand accountability for individual action. Every time the society grants a privilege to one of its members it also provides an ID number, which acts as the linkage between that privilege and the accountability that necessarily follows it.

Every user of the network 10 is fully registered and is given a user ID 16, 17, also known as a registration number or a personal user number, for use on the network 10. A unique registration number will be necessary for individuals to roam on the network 10. This registration number is keyed to an existing credit card system so that a physical person can be traced in relation to an ID number.

Therefore the goal of accountability is established through the use of personal user numbers.

Every user of the network 10 is fully registered and has a user ID. The host software for the Safe Net also carries a unique number (product ID). Every single file that is transmitted across the network 10 is given a unique file ID.

The host software creates a TAG for all files with all three ID numbers, namely user ID, file ID, and product ID, as well as date and time. This TAG is not destroyed even if the original file is deleted.

Every time a file is received via the network 10, it is checked for the presence of a TAG. A file without a TAG will preferably not be processed or alternatively the user will be positively informed about the file's suspect status. Files without a TAG are also forwarded to the Safe Net security system for security reporting.

If the received file contains a valid TAG then its TAG is modified immediately by adding the various ID numbers of the receiving person and the computer. The TAGs record an event history of every file that is created and are thus provide traceability of modifications to and transmissions of files.

As soon as a user starts the Safe Net application 18, 19, it sends the user's TAG to the TAG archive 20. From this point on every activity of the user on the network 10 is logged on the Archive via modified TAGs. The Tag Archive 20 consists of a set of servers located on the Internet for the purpose of monitoring TAG activity of all of users of the network 10,

The TAG system and the Archive TAG 20 jointly provide traceability of the activities of all users of the network 10.

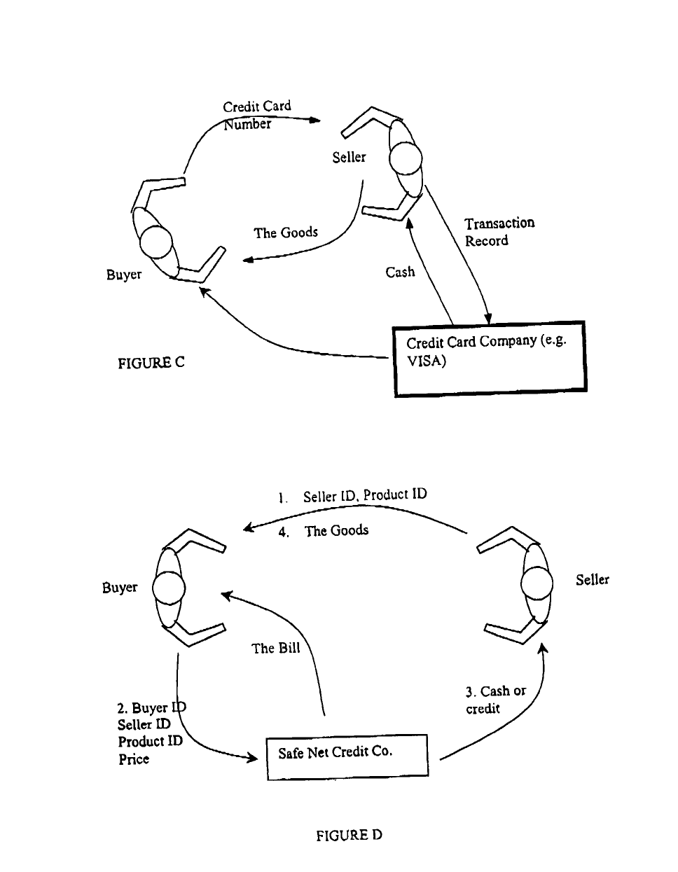

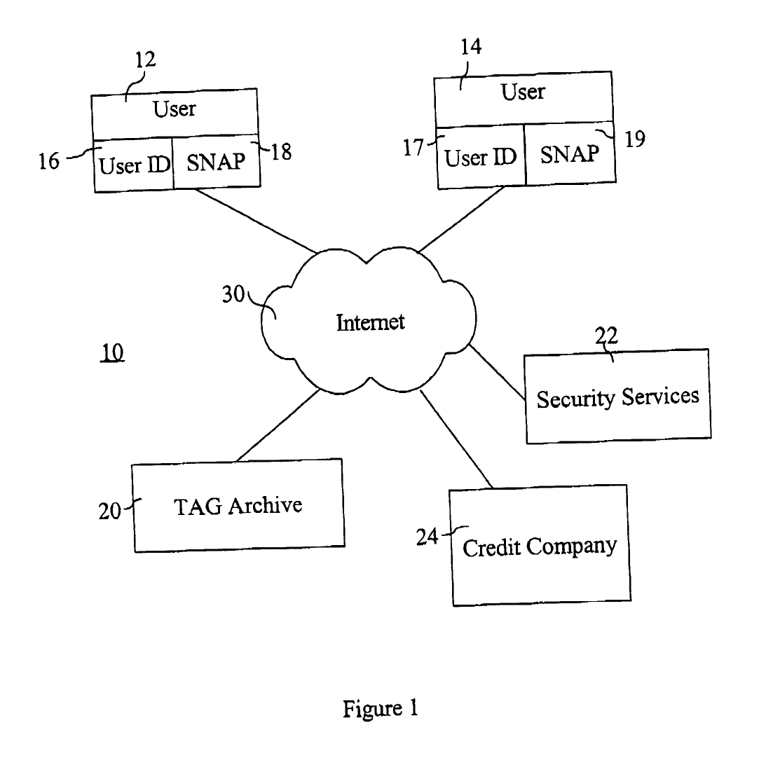

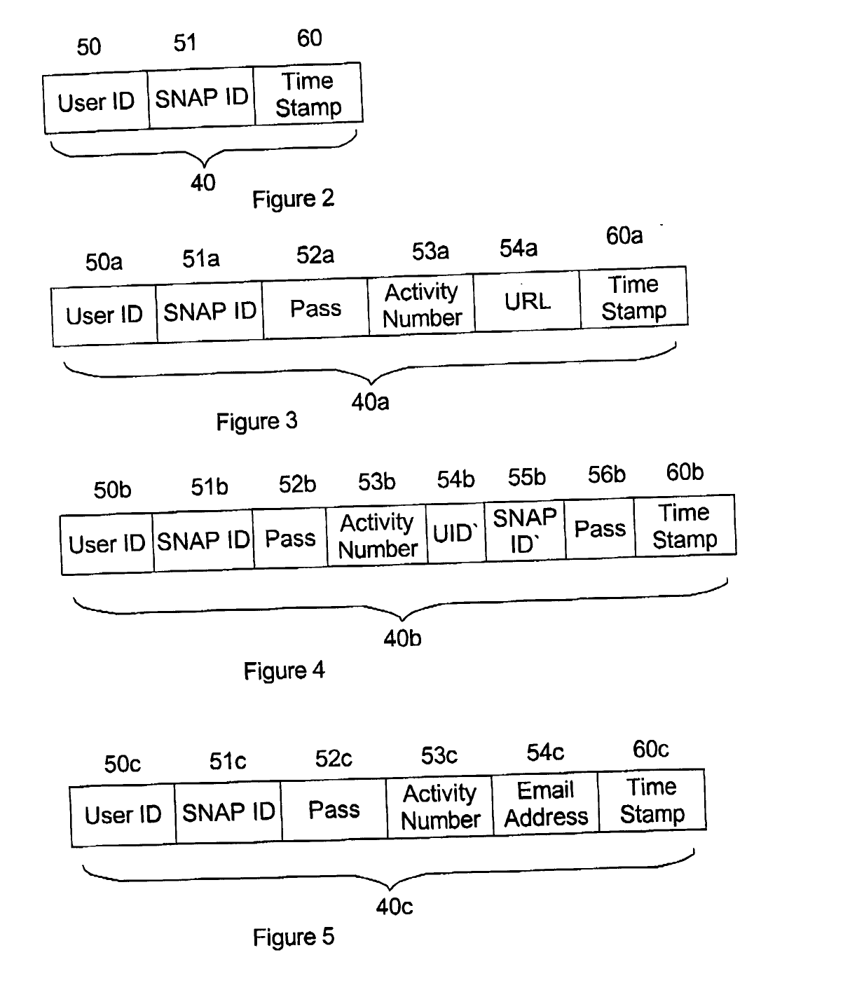

Referring to FIGS. 2, 3, 4, and 5, exemplary TAGs for use with the TAG Archive are shown generally by the numerals 40, 40a, 40b, and 40c. Each TAG comprises a USER ID 50, 50a, 50b, 50c, a SNAP ID 51, 51a, 51b, 51c, and a Time Stamp 60, 60a, 60b, 60c. The combination of a user ID, a SNAP ID, and a Time Stamp will be referred to as a basic TAG. A permit request TAG 40 is shown in FIG. 2 and has the basic TAG structure. As shown in FIG. 3, an activity TAG 40a includes the basic TAG and a Pass 52a, an Activity Number 53a, and a URL 54a. As shown in FIG. 4, a check and verify TAG 40b includes the basic TAG and a Pass 52b an Activity Number 53b, another USER ID 54b, another SNAP ID 55b, and another Pass 56b. As shown in FIG. 5, an email TAG 40c includes the basic TAG and a Pass 52c, an Activity Number 53c, and an Email Address 54c.

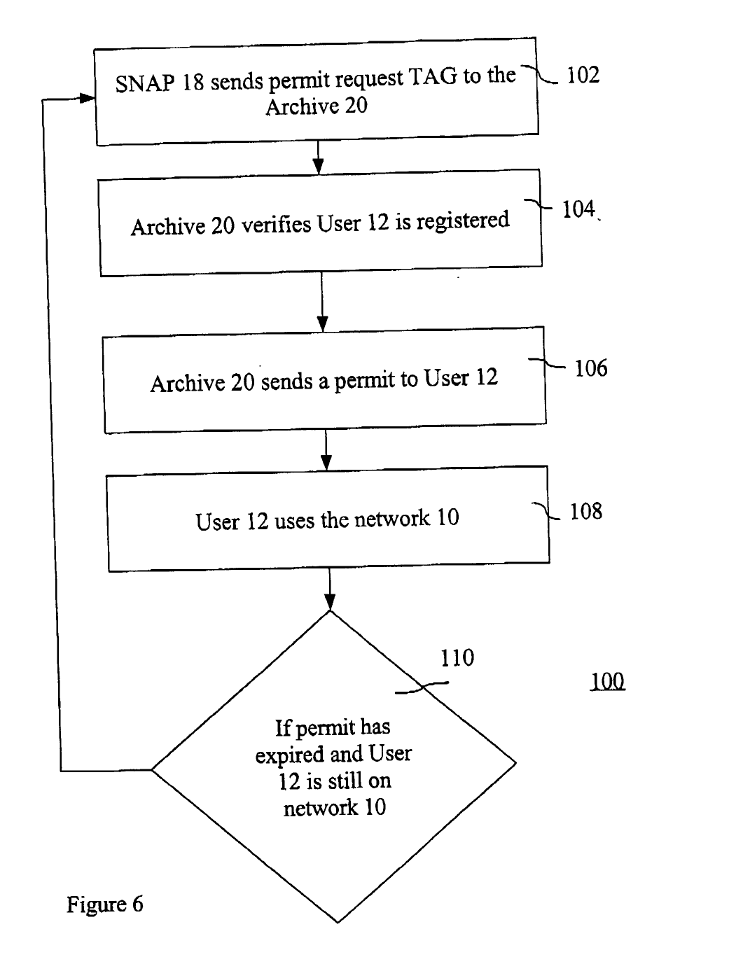

Referring to FIG. 6, a method of logging on to the network 10 is shown generally by the numeral 100. The first user 12 wishes to log onto the network 10. It is assumed that the first user has already registered with the network 10, and thereby obtained its User ID 16. The SNAP 18 sends 102 a permit request TAG 40 to the TAG Archive 20. The Archive 20 verifies 104 that the first user 12 is registered. If the first user 12 is registered, then the Archive sends 106 a permit to the first user 12. Then the first user 12 uses 108 the network 10. If and when the permit expires and the first user 12 is still on the network 10, then step 102 is repeated 110 to obtain a fresh permit.

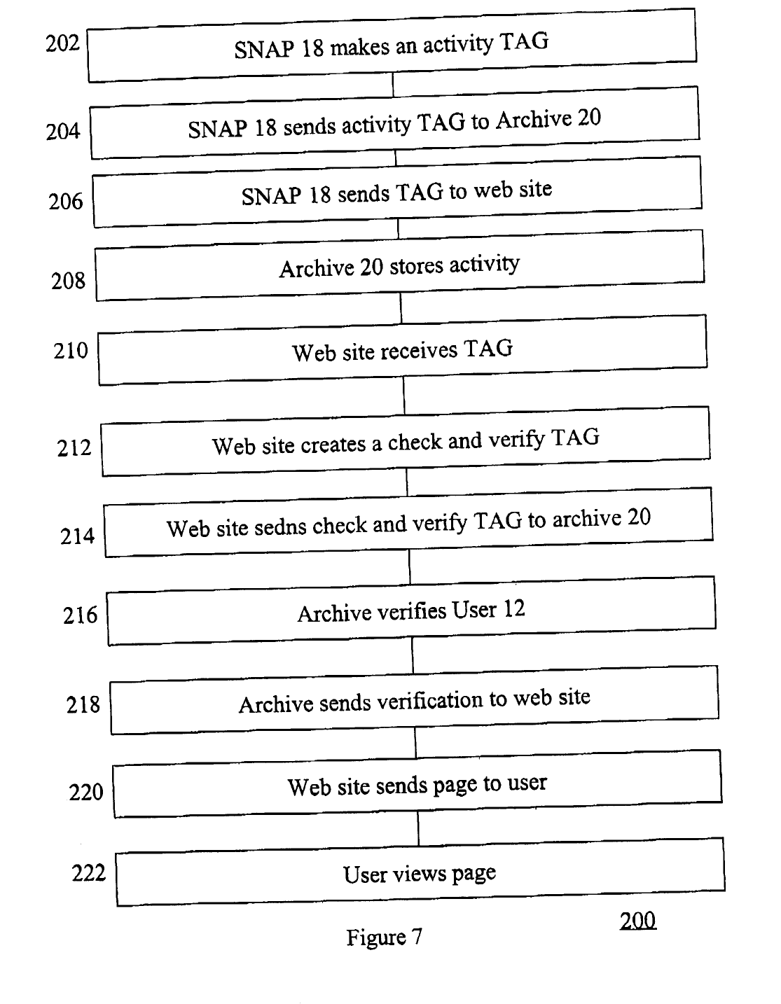

Referring to FIG. 7, a method of downloading a file through the network 10 is shown generally by the numeral 200. The first user 12 wishes to download a file or web page from the second user 14. The first SNAP 18 makes 202 an activity TAG 40a. The first SNAP sends 204 the activity TAG 40a to the TAG Archive 20. The first SNAP 18 then sends 206 the activity TAG 40a to the second user 14. The TAG Archive 20 stores 208 the activity TAG 40a. When the web site receives 210 the activity TAG, it creates 212 a check and verify TAG 40b. The web site sends 214 the check and verify TAG 40b to the TAG Archive 20. The TAG Archive 20 verifies 216 the first user, and sends 218 the verification to the second user 14. The second user 14 then sends 220 the file to the first user 12. The user then views 220 the received file.

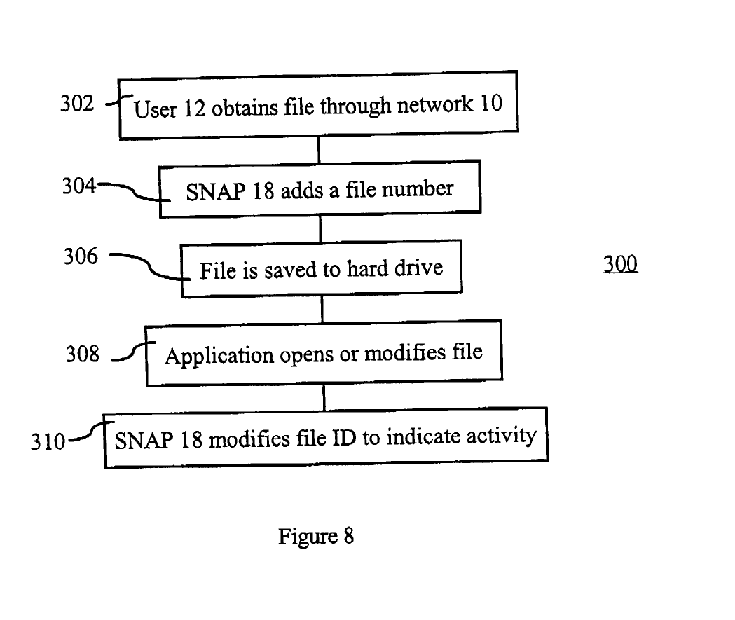

Referring to FIG. 8, a method of modifying a file obtained from the network 10 is shown generally by the numeral 300. The first user obtains 302 a file through the network 10. The SNAP 18 then adds 304 a file number to the file. The file is then saved 306 to the user's storage means, preferably a hard drive. When an application opens 308 or modifies the file, the SNAP 18 modifies 310 the file ID in a predetermined manner to indicate the activity performed on the file.

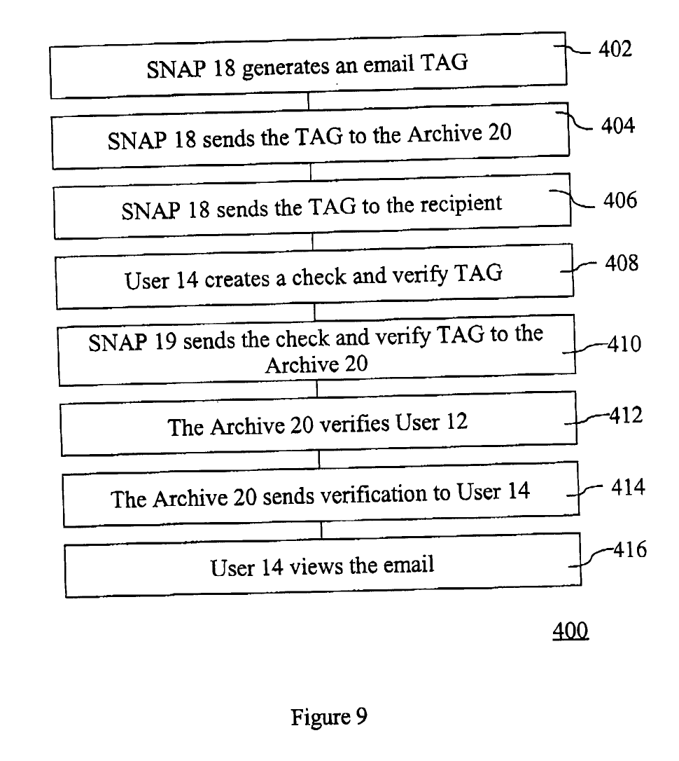

Referring to FIG. 9, a method of emailing a file through the network 10 is shown generally by the numeral 400. The SNAP 18 generates 402 an email TAG. The SNAP 18 then sends 404 the email TAG to the TAG Archive 20. The SNAP 18 also sends 406 the email TAG to the second user 14. The second user 14 creates 406 a check and verify TAG and sends 410 the check and verify TAG to the TAG Archive 20. The TAG Archive 20 verifies 412 that the first user 12 is registered with the network 10 and sends 414 the verification to the second user 14. The second user then views 416 the email.

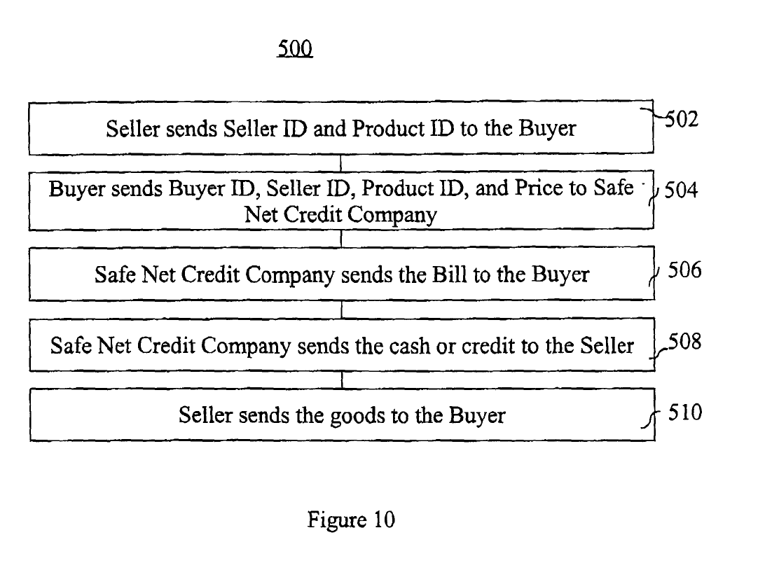

Referring to FIG. 10, a method of processing a credit card payment through the Safe Net is shown generally by the numeral 500. The term “credit card” is used to generically refer to an electronic payment instrument settled through a financial institution such as a credit card company or a bank. Ocher payment instruments that provide credit or debit accounts may also be used. A seller sends 502 its seller ID and a product ID to a buyer. The buyer sends its buyer ID, seller ID, the product ID, and a price to the Safe Net Credit Company 24. The Safe Net Credit Company 24 sends 506 the bill to the buyer and sends 508 the payment to the seller. Upon receiving the payment, the seller sends 510 the goods to the buyer.

The following example will illustrate some of the characteristics of the TAG system, the Tag Archive 20 and the communication protocol involved.

In this example, the first user 12 and the second user 14 are both registered members of the network 10 and the first user 12 downloads a file from the second users 14's site, modifies this file and e-mails it back to the second user 14.

The first user 12 logs onto the network 10 by initiating the Safe Net Application (SNAP) 18 on a local computer, which performs the method of FIG. 6.

1. SNAP 18 sends the following TAG 40 to the Archive 20

| | | |
|---|---|---|
| User ID 1 | SNAP ID | Time stamp |

2. The Archive 20 verifies that the first user 12 is a registered user and sends back a live permit. This permit allows the user to operate on the network 10. It is called live since these permits are created with a definite expiry duration that might vary from an order of minutes to hours or days depending upon the characteristics of the user. Upon expiry of the permit, if the user is still on the network 10 and remains so, then the SNAP 18 automatically asks for and receives another permit from the Archive.

3. Upon receipt of the permit from the Archive SNAP 18 makes a new TAG 40a

| | | | | | |
|---|---|---|---|---|---|
| User ID 1 | SNAP ID 1 | Pass for U1 | Activity # | URL | Time stamp |

This TAG is sent by SNAP 18, both to the Archive 20 and to the site that the first user 12 wants to view. In this case the Activity number will correspond to “viewing a web site.”

4. TAG Archive 20 stores the activity under the database entry for the first user 12.

5. The site of the second user 14 that is being visited by the first user 12 picks up the TAG from the first user 12 and creates the following TAG 406

| | | | | | | | |
|---|---|---|---|---|---|---|---|
| UID 2 | SNAP | Pass | Activity | UID 1 | SNAP | Pass | Time |
| | ID 2 | for U2 | # | | ID 1 | for U1 | stamp |

And sends this TAG 406 to the Archive 20. In this instance the Activity Number corresponds to “check and verify user”.

6. The Archive checks this information against its database on the first user 12 and verifies its authenticity. It then sends verification to the SNAP 19 of the second user 14.

7. The specific resource that was requested by the first user 12 is then displayed on the first user 12's computer screen.

8. If the first user 12 chooses to save this specific file on its hard drive then a file number is added by the SNAP 18 to that specific file that is being created. This number can be generated locally by the SNAP 18 by various means ranging from a high value random number to a time stamp based number. When combined with the USER ID and SNAP ID the joint number becomes unique for identification of this specific file.

9. If any application on the first user 12's computer opens and modifies the file that was downloaded then the file ID number is modified in a predetermined manner by SNAP 18 to indicate this particular activity on the file. File ID numbers will remain with all of the files that are created or moved through the network 10.

10. The first user 12 now wants to send this file back to the second user 14 through the use of e-mail. In this case SNAP 1 will generate the following TAG 40c;

| | | | | | |
|---|---|---|---|---|---|
| User ID 1 | SNAP ID 1 | Pass for U1 | Activity | e-mail | Time stamp |
| | | | # | address | |

11. The process as shown on steps 3-7 for the first user 12 will be repeated in a similar manner by the second user 14 to ensure authenticity of both the second user 14 and its activities on the network 10.

Like all licensed activities in our society, traffic on the network 10 will also be open to a certain amount of abuse and lawlessness, But over time, organizations and societies develop ways and means to minimize such activities.

It is important to note that the existence of network 10 will not detract from the Internet, as we now know it. A user will be able to use the Internet and the network 10 simultaneously through the same browser. The SNAP software 18, 19 will function as a plug-in to all available browsers. It may also function as a standalone program. The users of the network 10 will be able to send and receive data from other users who are not members of the network 10, but these files are clearly identified for the user's benefit. It is expected that, over time, financial transactions, official company business, and all other correspondence that necessitates a more secure environment will move through the network 10. The Internet and the network 10 exist concurrently.

The network 10 includes two internal organizations to provide greater service to the users 12, 14:

1. Safety Net Security Service 22

This organization functions in a similar way to the police in our society. It investigates all Network Security related issues. Any security infringement on the Safe Net that is traced and documented by the Security Service is turned over to local authorities along with the evidence for the purpose of prosecution of the invaders. The Security Service is bound by the same set of rules that the police operate under.

2. Safe Net Credit Company 24

The purpose of this organization is to establish and maintain a secure and reliable financial transaction service within the network 10.

The Safe Net Credit Company 24 differs from existing systems in a fundamental manner and follows a different credit flow pathway. FIG. 10 shows this alternative transaction method.

When using the Safe Net Credit Company 24, the “credit card number” of the purchaser is never released to the seller thereby substantially eliminating the possibility of fraud by the seller. Furthermore each purchase is also correlated with a User ID and a SNAP ID. The Archive 20 also tracks the interaction between the buyer and the seller prior to the finalization of the transaction.

With the Safe Net Credit Company 24, the credit card numbers and other personal information about the purchaser should never be transmitted on the internet. Furthermore the merchants should not have credit card numbers of their customers since web merchants go out of business frequently and the fate of their databases containing this and other information is always questionable. It is also preferable that the broad protocol for the network 10 be able to prevent both the merchant and the purchaser against various known attacks.

These goals are preferably accomplished without resorting to complicated encryption technologies, proprietary WANs, LANs and/or other token based or biometric systems.

Potential clients of the Safe Net Credit Company 24 who have a “good” payment track record for their credit cards (Visa, Master Card, phone companies etc can be substituted or combined) receive an invitation to activate secure Internet transaction capabilities. This letter contains their personalized PIN number (which can be changed to another number or a phrase later on).

The potential customers go to their bank's web site, or a special web site, to log on using this number and download a self-extracting and installing application, namely the SNAP 18, 19 (Safe Net Application).

Each application that is downloaded by a purchaser will have a unique embedded product identifying number/Tag. Upon installation of this application on a client's computer the application modifies the product identification number using identifiers from the hardware components of that particular computer. This modified number will be referred to as the SNAP ID (Safe Net Application Identification) in the text below.

The registration process is completed when the client gets on the Internet the next time. At this point the application sends the new modified ID and the original ID to the Safe Net central server. The user also creates a pass phrase and user name. Neither is stored on the PC, but rather in the Safe Net central server.

Merchants install the Safe Net merchant software package on their server. This package includes a Kerberos key, which will be used to identify the merchant on the Safe Net. Only the merchant and the Safe Net central server know the merchant's Kerberos key.

In the example below it is assumed that both the buyer and the seller (Web store) are registered members of the network 10. It is also assumed that throughout this protocol the usual Internet based technologies are utilized including the HTTP (HyperText Transfer Protocol), SSL (Secure Sockets Layer) etc.

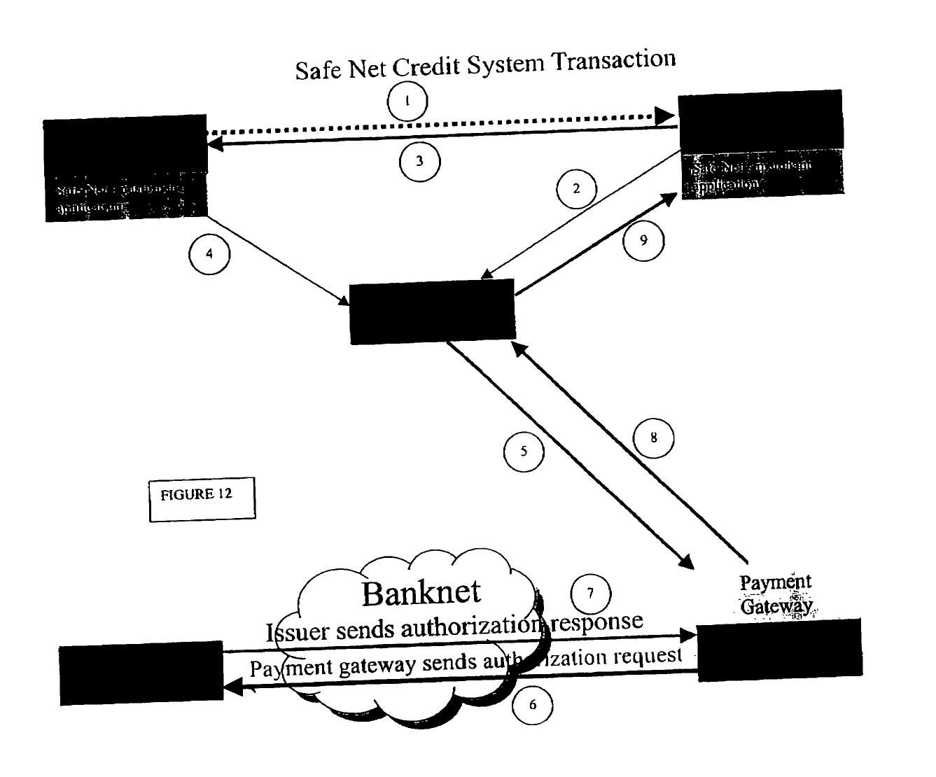

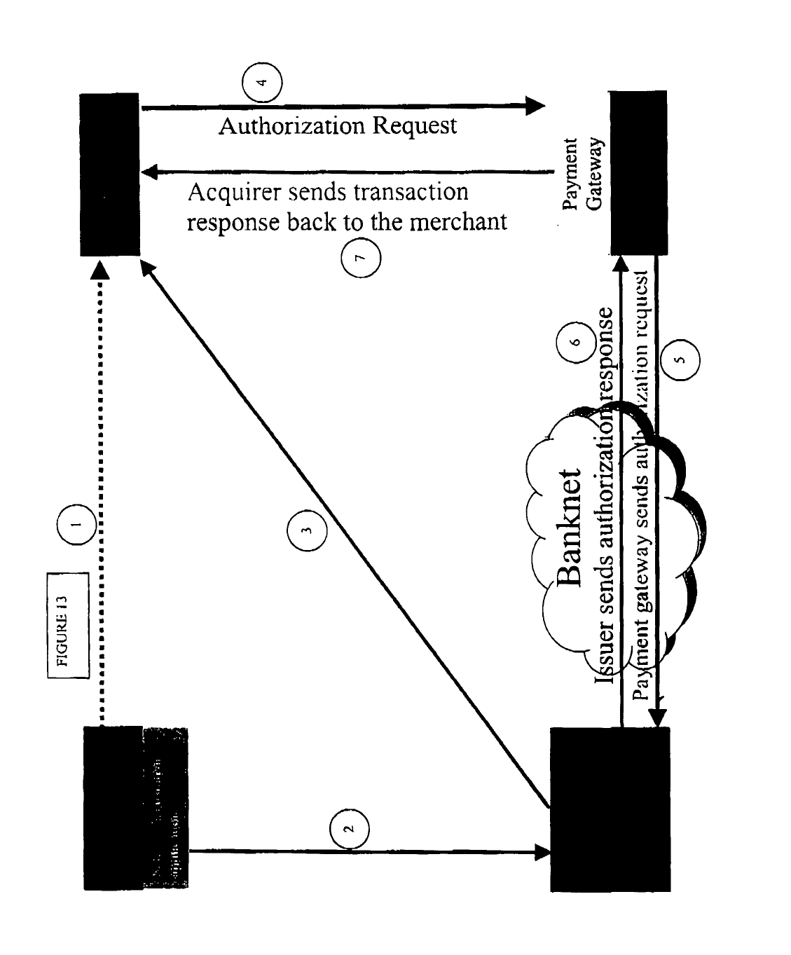

Referring to FIG. 12, the connection between the merchant and the Safenet server is an SSL connection and as well the connection between the purchaser and the Safenet server is also an SSL connection. The SSL connection provides secure communication between the respective parties. Other types of secure connections could also be used. However, no assumptions are made for the connection between the purchaser and the merchant.

### EXAMPLE

1. Purchaser visits a web store, does shopping, and brings a shopping cart to check out. The shopping cart holds a list of items and their respective prices. The price is tallied, and the site asks for a payment method. Purchaser selects his preferred payment method

2. The “clicking” of button, which is used to end the shopping activity on the merchant's web page, initiates a “request to log on” signal from the merchant's server to the Safe Net Server. This process involves sending to the Safe Net server the SNAP ID of the Merchant's SNAP. Safe Net sends back to the seller a live permit (see the end of this document for the description of the live permit) encrypted using the merchant's secret key (Kerberos). Merchant's SNAP modifies the live permit in a predetermined manner and sends it back encrypted in the same manner immediately. The Safe Net central server checks to verify if the modification to the live permit was in the pre-approved manner, as set forth more fully below. If this test is successful then the merchant becomes live on the Safe Net for the duration of the permit. After becoming “live” on the Safe Net, the merchant's server sends to the Safe Net, over the SSL connection:

a. A unique transaction ID associated with this particular transaction

b. Shopping cart content and cost and customer's preferred payment method

c. A time stamp as in FIG. 2

3. The merchant sends back to the purchaser

a. The transaction number

b. Shopping cart content

c. Time stamp

d. MIME type helper application.

The MIME type helper application received by the purchaser's SNAP terminates the communication between the purchaser and the merchant.

4. In response to the incoming MIME type helper application, the purchaser's SNAP pops up a window containing the following fields:

a. Purchaser Login ID Field: purchaser needs to input his/her ID into this text field.

b. Purchaser Password Field: purchaser needs to input his/her password to this text field.

c. Reset Button: clicking this button will clear the contents in the ID and password field.

d. Login Button: clicking this button will communicate to Safe Net server with specified ID and password.

e. Real Time Transaction Monitor: any transaction process message will be displayed in this window. The second line in this window displays the purchaser phrase. This phrase is stored in purchaser application environment setup file and was chosen during the registration process of the purchaser to Safe Net to ascertain that the observed pop up window is originating from the purchaser's computer and not due to some malicious applet ran by an outsider.

f. Order Window: The shopping cart contents will be listed in the window.

g. Transaction Confirmation Button: if login successful, this button will be highlighted. Clicking this button will result in confirming the current transaction.

h. Cancel Button: Clicking this button will cancel the current transaction and terminate the program.

When the purchaser fills out the “purchaser log in ID” and the “password” fields and clicks on the login button, the Purchaser SNAP sands to the Safe Net server the information that is filled in the aforementioned fields and the embedded SNAP ID. If the purchaser presses the “confirm”button before the transaction times out then the purchaser's SNAP sends to the Safe Net server:

a. The unique transaction D that was received from the merchant

b. The contents of the shopping cart including price and payment method.

For the purposes of this example we are combining the actions of the “log-in” button with the “confirm” button.

The Safe Net Server identifies the matching transaction numbers and compares the transaction records

a. Reconciles the two identical shopping cart contents prices and payment methods.

b. Verifies that two time stamps and two live permits overlap

c. If all entries reconcile then

Safe Net identifies the card number of the purchaser from its database (offline and secure)

Safe Net identifies the gateway of the merchant

5. Safe Net connects to the acquiring bank through the merchant's payment gateway requests transaction clearance.

6. Payment gateway sends the authorization request to the Issuing bank

7. Issuing bank approves the transaction and issues an authorization number.

8. The merchants payment gateway returns this authorization number the Safe Net server.

9. Safe Net sends back to the Merchant

a. Transaction verification number and the credit card authorization number

b. Purchaser's Shopping cart content and value

c. Purchaser's shipping address (obtained from the Safe Net database)

The Purchaser receives an e-mail and/or notification indicating

a. Transaction verification number

b. Shopping cart content and value.

As a result of this protocol the credit card numbers, expiration dates are not exchanged over an unsecured channel such as the Internet. The purchaser receives the goods at the same address that he receives his credit card invoice. The above example assumed purchases via credit cards. The Safe Net protocol also allows the purchaser to register its selected bank accounts with Safe Net and debit this account through Safe Net. Debit cards can also be used with this system.

Discussion on Live Permits

The purpose of live permits is to prevent play back fraud. The communication between the purchaser and the Safe Net server or the merchant and the safe net server can possibly be recorded and then be played back to the Safe Net Server even though these lines are both secured with SSL.

The validity of live permits that are sent from the Safe net to the client can be anywhere from few seconds to minutes depending on the application.

The Safe Net Application has an embedded mathematical formula and a random number file. The Safe Net server also has the same information.

The client's SNAP modifies the permit using the embedded mathematical formula and the set of the random numbers as input parameters to the formula. Upon receipt of a modified random number by the client's computer the Safe Net server checks to see if the modification is valid. For a client to log on to the Safe Net server this particular set of procedures have to be performed correctly.

If the permit happens to have a lifetime of 10 seconds then after the completion of this duration the client's SNAP automatically asks for another permit from the server and repeats the above process.

With this approach, someone capturing the on line communication between the client and the Safe Net server has to reverse engineer the precise character of the mathematical formula and the complete set of predetermined random numbers that are used in conjunction with this formula. Only then it is possible to impersonate a client on the net.

It will be recognized that the Safe Net protocol mitigates some known fraud attacks as follows.

Fraud Originating From SNAP ID Related Issues.

The connection between the physical user, his/her and the SNAP ID will be established during the actual online registration process through the use of a PIN number that is created by the card issuing bank and physically mailed to the user. SNAP IDs will be stored on the users'SNAP application embedded into the machine code.

If same SNAP software could be installed on two different machines then this situation would lead to replication of the same mathematical formula and the random number array on two different physical computer systems. As a result the incoming live permits will be modified by the SNAPs in the same manner by two different machines. This would not be a problem as long as the resultant SNAP IDs are unique.

There are two distinct aspects to this problem:

a) Capturing the uninstalled executable prior to its installation If the uninstalled executable is captured and installed on two different computers then two different SNAP IDs will result upon completion of the registration process. This case will not be a cause for concern since both unique SNAP IDs will be connected to the known user during online registration.

If the captured executable is installed on two physically identical computers then this might result in creation of two Identical SNAP ID s. Including time codes into the SNAP ID can circumvent this difficulty.

b) Removing the hard disk from a computer which has the SNAP already installed

The SNAP application will verify its environment upon power up. This can be accomplished by re-performing the operation that led to the unique SNAP ID starting from the original, embedded product ID. If the new SNAP ID does not match the old one, then the operation of the SNAP can be interrupted.

Communication playback type attacks:

a) Recording the communication between the merchant and Safe Net Server. This connection is an SSL line. Even if this line is breached then the only information that is exchanged between the merchant and the Safe Net server is the unique transaction ID for that session between the merchant and the purchaser and the shopping cart content. No financial or other benefit can be derived from this information. Furthermore the live permit issued by the Safe Net server during the playback session will be different than the one that was previously recorded and hence live permit activity will fail for such a transaction.

b) Recording the communication between the purchaser and Safe Net Server. This is also an SSL line. It also has the live permit facility built in.

c) Recording both simultaneously It will be recognized that such recording is relatively difficult to do. Even if it were accomplished, then it has the same live permit protection

Stealing of the pass phrase and user name

If both the pass phrase and the user name is stolen from the user then this information cannot be used by a third party on a PC with a SNAP since the SNAP ID of that PC will not match the user pass phrase and name. The only way to have all three coincident is if the user's PC, pass phrase and user name are all stolen at the same time. Even the theft of all three will not necessarily lead to fraud due to the shipping address issues set forth below.

Malicious Applet Attack on the Purchaser's Computer

The pop up window on the purchaser's computer can be simulated through a malicious applet. Such an applet can create a window that looks exactly like the original one and if the user fills in the user name and pass phrase then it can transmit this information to a third party.

To disable such an attack, the SNAP's Pop Up window uses a phrase chosen by the user during the registration process that is stored on that computer's hard drive. The user can easily verify the existence of this phrase to ensure himself that the pop up window is created by a resident application and not an applet from a hacker.

It will be recognized that the next level of attack might include applets that search the known hard drive location for the special “user phrase” and subsequently display this phrase. In a further embodiment designed to protect against such an attack, all such information is stored on the user's hard drive encrypted. However, it is recognized that the addition of encryption of the user phrase may render the complete system more difficult to use.

Fake Web Stores

It will be recognized that the possibility of committing credit card fraud through the use of fake web stores is mitigated. An illegitimate merchant will not have a connection to the Safe Net server. Thus the merchant to Safe Net connection will be missing from the verification stage with the Safe Net server.

Friendly Fraud

If a user purchases an item from a web store via Safe Net legitimately, and if the transaction is allowed by the system then the user will not be able to claim that he/she never purchased the item due to non-repudiation capability of Safe net. The non-repudiation capability results from including the user ID, password and SNAP ID in the verification stage with the Safe Net central server.

Use of Stolen Cards on the Web

Most use of stolen cards on the web is not possible with Safe Net Users will not be able to “add” credit cards to their Safe Net profiles without first receiving the invitation letter from their issuing bank, which includes a specific credit card number.

Shipping Address Issues

The default shipping address of the goods that are purchased is the billing address for the credit card of the user. Users are able to redirect the purchased goods but for this they will have to answer several challenges successfully. These special challenge questions and their answers are established during the initial registration.

In another embodiment, the Safe Net Credit System operates in a truncated, subset form. In this instance the triangle between the purchasers, the safe net server and the merchant can be broken and the connectivity between the Safe Net system and the merchant can be dropped out of the requirements. In this truncated version only the connectivity between the purchaser and the Safe Net server is maintained. In FIG. 13, the Safe Net server is shown to have a specific relationship with an issuer. Having similar relationships with more then one issuer is also completely possible

Referring to FIG. 13, the Safe Net's partner issuer (or issuers) either provides (issues) new credit cards to applicants or registers the existing cards for Internet/Safe Net usage. If the applicant (purchasers in our previous example) does not have an existing card then the applicant goes through an online credit card application process. Upon approval, the applicant is informed through via mail or another secure system, which will include a PIN and is invited to visit a web site to upload the Safe Net application (SNAP). The installation of the General Form of the SNAP application creates a special button on the web browser (this button will be called “P4M” button meaning “Pay for Me”)

Once the system is in place the following is the messaging protocol between the parties involved:

1. Purchaser visits a web store, does shopping, brings shopping cart to check out. The purchaser at this point clicks on the P4M button on his browser.

2. The “clicking” of the P4M button, initiates a “request to log on” signal and the purchaser logs on as described above. Purchaser's SNAP application forwards the merchant's shopping cart page to the Safe Net server along with a unique transaction number.

3. The Safe Net server generates a credit card number and tags this number to the purchaser's original card number. The Safe Net server fills the merchant's shopping cart page using this number and with the shipping information from its database and submits the shopping cart page back to the merchant.

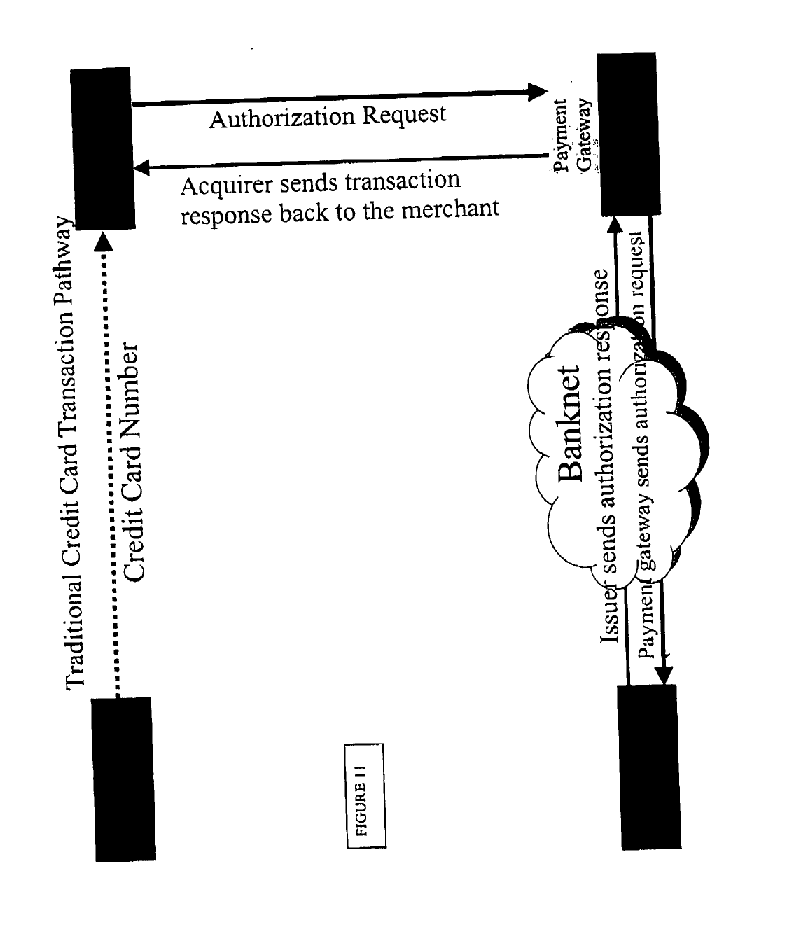

The remainder of the process proceeds as shown in FIG. 11.

The reduced version of the Safe Net Credit System potentially brings the following benefits:

1. Credit card information of the purchaser is not used directly;

2. Merchants do not have to modify their servers;

3. In-store credit cards can be registered for use on the internet as long as the issuer of those cards can approve transactions;

4. If the purchaser registers specific bank accounts with the Safe Net server then these accounts can be selected by the purchaser for direct debit. This transaction goes through ACH system;

5. Debit cards can be used in the same manner.

In both the reduced and the full versions of the Safe Net system the purchaser's PC can be replaced by:

1. the purchaser's cell phone or a PDA (Personal Digital Assistant)—wireless Safe Net; or

2. a combination of a public Internet kiosk and his cell phone—Public kiosk with a wireless device; or

3. a public Internet and a personal ID card with a magnetic stripe—Public kiosk without a wireless device.

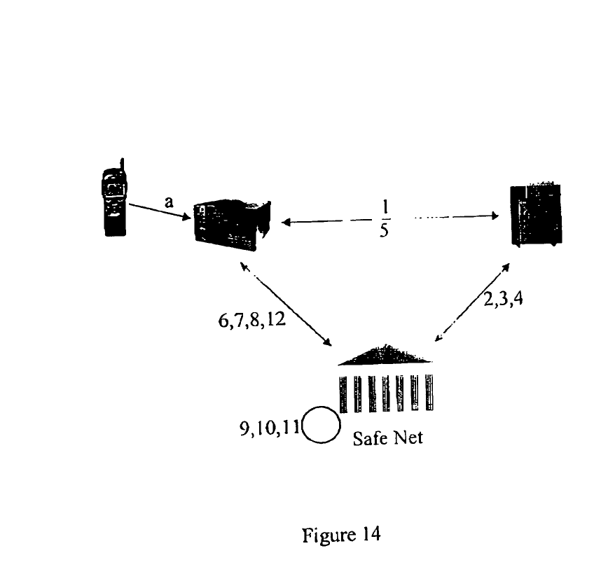

In another embodiment of a cell phone replacement for a purchaser's PC the system works mostly as a proximity-purchasing device, as shown in FIG. 14. Merchants and their goods are assigned unique numbers and these are displayed by the merchant. A Safe Net client who happens to be in the proximity of the merchant's location and sees an item that he would like to purchase dials the numerical coordinates of the item on his cell phone to complete the purchase.

In this example his cell phone communicates with Safe Net's IVR, the voice recognition unit. IVR converts the data elements originating from the cell phone and populate an XML file, which can be recognized by the merchant's web site. The rest of the transaction between the parties will follow the communication lines indicated in FIGS. 12 or 13.

In a further embodiment, a wireless phone interface is added to the Safe Net application 18, 19 that uses the architecture defined above. The wireless device will act through an IVR system that behaves the same way as an Internet browser.

Sample Wireless Session with Wireless Safe Net

Client is in the proximity of a film theatre and would like to see Star Wars. The client notices the SafeNet logo and SafeNet location and items available for purchase as follows:

Famous Players

SafeNet - 1138
Theater 1 - 2 Adults - 0 Kids = 120
. . .

The client dials: 1800 SAFENET

SafeNet responds: “Welcome to SafeNet, please enter the merchant number”

The client enters: 1138#

SafeNet responds: “You are at Famous Players please enter the item you wish to purchase”

The client responds: 120#

SafeNet Steps 1,2,3,4,5

SafeNet responds: “Your VISA card will be charged ###. press 1 to confirm”

The client responds: 1

SafeNet Steps 6-12

SafeNet responds: “Thank you your tickets are now available, your transaction code is ###”

Functions of the IVR

The IVR will require two functions (or definitions for implementing two functions)

→data elements to Merchant or SafeNet

←data elements returned from Merchant or SafeNet

Message Sequencing in the Wireless Safe Net

Transaction initiated from IVR and responded to by Merchant.

| | | |
|---|---|---|
| ID | → | Entered by the customer or built into the |
| | | wireless device |
| ShoppingCart | → | item to be purchased |
| SuccessOrFailure | ← | if not OK then the reason the transaction failed |
| | | ie out of stock, bad item, etc |
| Seller SNAPID | ← | |
| Purchaser SNAPID | ← | |
| ShoppingCart | ← | echoed back |
| TimeStamp | ← | |
| Permit | ← | |
| TransactionNumber | ← | |

Confirm Purchase
Transaction initiated from IVR and responded to by Safe Net

| | | |
|---|---|---|
| PurchaserSNAPID | → | |
| SellerSNAPID | → | |
| ShoppingCart | → | |
| TimeStamp | → | |
| Permit | → | |
| TransactionNumber | → | |
| SuccessOrFailure | ← | if not OK then the reason the transaction failed |
| | | e.g. out of stock, bad item, etc |
| ShoppingCart | ← | |
| TransVerification | ← | |

In another embodiment, the Safe Net infrastructure is accessed through public Internet terminals (i.e. Internet kiosks). Access to Safe Net through public kiosks can be done in one of two ways:

1. Customer is carrying a wireless device;

2. Customer accesses the system using a card with a magnetic stripe.

In both instances the customer surfs the net via a public terminal and decides on a purchase. When he is at the shopping cart page he dials a phone number that is displayed on the terminal. Once the phone connection between the terminal and the cell phone is established then the phone sends the encrypted SNAP ID associated with that wireless device to the public kiosk. The terminal simply forwards this message to the Safe Net server. Later on the user also enters his PIN number and pass phrase on his cell phone. All customer specific or security related data originates from the wireless device and is not entered into the public terminal. The remainder of the communication between the parties involved follows the same pathway as shown in FIGS. 12 or 13.

The second alternative assumes that the customer does not have a wireless device and/or his wireless device does not operate in that particular geographic location. In this case the system functions much like the ATMs where the customer is asked to swipe a card, which contains his SNAP ID and is followed by physical typing of his pass phrase and PIN.

Although the invention has been described with reference to certain specific embodiments, various modifications thereof will be apparent to those skilled in the art without departing from the spirit and scope of the invention as outlined in the claims appended hereto.

The embodiments of the invention in which an exclusive property or privilege is claimed are defined as follows:

1. A method of processing a credit card transaction between a seller and a buyer over a network using a credit company comprising:
a) the seller sending a sender identification and a product ID to the buyer;
b) the buyer sending a buyer ID, the seller ID, the product ID and a price to the credit company;
c) the credit company sending a bill to the buyer;
d) the credit company sending payment to the seller; and
e) the seller sending the product to the buyer.

2. A method according to claim 1, wherein the seller logs into the network before initiating communications.

3. A method according to claim 2, wherein the seller uses a permit to log into the network.

4. A method according to claim 1, wherein the buyer logs into the network before initiating communications.

5. A method according to claim 4, wherein the buyer uses a permit to log into the network.

6. A method according to claim 1, wherein the credit card company compares information received from the buyer to information received from the seller to verify the transaction.

7. A method according to claim 1, wherein the network stores a record of communications in an archive.

8. A method according to claim 7, wherein the archive verifies that the buyer is authorized to use the network.

9. A method according to claim 8, wherein the archive verifes that the seller is authorized to use the network.

10. A method according to claim 7, wherein the archive verifies that the seller is authorized to use the network.

11. A method of logging a user into a network comprising the steps of:
a) obtaining a user ID by registering with the network;
b) requesting a permit from an archive on the network;
c) the archive verifying that the user is registered with the network;
d) the archive sending the permit to the user.

12. A method according to claim 1, wherein the user and the network both include a mathematical formula and a random number file.

13. A method according to claim 12, wherein the request for a permit is performed by deriving a value from said mathematical formula and said random number file.

14. A method according to claim 13, wherein the archive verifies that the user is registered with the network by verifying the computation of said value.

15. A method according to claim 11, wherein the permit includes a validity period.

16. A method according to claim 15, wherein the user requests a new permit at the end of said validity period.

17. A method according to claim 16, wherein said validity period is about 10 seconds.

18. A method according to claim 11, wherein said user ID is generated by said network to be unique for each user.

19. A method according to claim 11, wherein said request for a permit includes said user ID, a SNAP ID, and a time stamp.

20. A method according to claim 11, wherein communications are monitored by a security service.

21. A method of communicating between a first user and a second user on a network, each user including a respective user ID and a respective SNAP ID, said method comprising the steps of:
a) the first user sending an activity request to archive on the network;
b) the first user sending the activity request to the second user;
c) the second user sending a verification request to the archive;
d) the archive verifying the first user and sending the verification to the second user.

22. A method according to claim 21, wherein said activity request includes said first user ID, said first SNAP ID, an activity number and a time stamp.

23. A method according to claim 22, wherein said activity request further includes a pass.

24. A method according to claim 22, wherein said verification request includes said second user ID, said second SNAP ID, said activity number, and another second time stamp.

25. A method according to claim 24, wherein said verification request further includes a pass.

26. A method according to claim 21, wherein said activity is downloading a file and said method further comprises said second user sending said file to said first user.

27. A method according to claim 21, wherein said activity is sending an email and said method further comprises said second user reading said email.

28. A method according to claim 21, wherein said activity is viewing a web page and said method further comprises said second user sending said web page to said first user.

29. A method according to claim 21, further comprising the steps of saving information received from said first user to a hard drive and adding a file number to the saved file.

30. A method according to claim 29, wherein said file number is randomly generated.
